(19) United States
(12) Patent Application Publication
(10) Pub. No.: US 2001/0032122 A1
(43) Pub. Date: Oct. 18, 2001

(54) Just-in-time advertising system

(76) Inventor: James Kirk Hankla, Long Beach, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/733,247

(22) Filed: Dec. 7, 2000

Related U.S. Application Data
(60) Provisional application No. 60/169,507, filed on Dec. 7, 1999.

(51) Int. Cl. G06F 17/60

(52) U.S. Cl. 705/14

(57) ABSTRACT

A system for distributing advertising data electronically is disclosed. A server computer is configured to store advertising data. A communication module is located in the server computer. The communication module is configured to transmit the advertising data to one or more display computers. A software module residing on the display computer. The software module is configured to display the transmitted advertising data. The advertising data may include audio data, graphic data, video data and/or text data. The communication module may be configured to transmit data over a network such as the Internet. The communication module may be configured to transmit data via a File Transfer Protocol (FTP) connection.

### RELATED APPLICATION

This application claims the benefit of priority under 35 U.S.C. § 119(e) of U.S. Provisional Application No. 60/169,507, filed Dec. 7, 1999, the entirety of which is hereby incorporated by reference.

### BACKGROUND OF THE INVENTION

1. Field of the Invention

The invention relates to advertising systems. In particular, the invention relates to a system and a method for electronic distribution and display of advertising material.

2. Description of the Related Art

Many modes of in-store advertising exist in today's supermarkets and other outlets. For example, vendors, manufacturers or other advertisers may place their logo on shopping carts belonging to a grocery store. The grocery store may sell the advertising space to the advertiser on a per-cart/per-month basis. Other in-store advertising modes include printing logos on back of receipts and posting flyers throughout a store.

However, these modes do not allow rapid modification of the content of the advertisement. For example, if the advertiser is a local realtor, he is unable to advertise the availability of particular homes since he cannot readily update the price or availability. Additionally, these conventional advertising modes do not allow an advertising system administrator to quickly update the distribution of the advertisements. For example, an advertiser may wish to direct his advertisements to a different demographic. In order to change, for example, from one chain of outlets to another, the advertisements must be physically removed and replaced in the other outlet. As a further example, an advertiser may wish to transfer some of his advertisement space to another advertiser. Again, the advertisements must be physically removed and replaced.

### SUMMARY OF THE INVENTION

An object of the invention is to provide an advertisement system that allows quick and easy modification to the content of the advertisements. Another object of the invention is to provide ready modification to the distribution of the advertisements.

According to one embodiment of the invention, a system for providing advertising comprises a server computer configured to store advertising data; a communication module located in the server computer, the communication module being configured to transmit the advertising data to one or more display computers; and a software module residing on the display computers, the software module being configured to display the transmitted advertising data. The advertising data may include audio data, graphic data, video data and/or text data. The communication module may be configured to transmit data over a network. The communication module may be configured to transmit data via a File Transfer Protocol (FTP) connection.

According to another embodiment of the invention, a method for distributing advertising data comprises storing advertising data on a server computer; transmitting the advertising data to one or more display computers; and displaying the transmitted advertising data on the display computers. Transmitting may include accessing a database to determine to which of a plurality of display computers to transmit the advertising data. Transmitting may include updating the database to indicate the transmission.

### BRIEF DESCRIPTION OF THE DRAWINGS

FIG. 1 is a block diagram of one embodiment of an advertising system.

FIG. 2 is a screen shot of a sample advertisement.

FIG. 3 is a flow chart illustrating one embodiment of a method for distributing advertising data.

### DETAILED DESCRIPTION OF THE PREFERRED EMBODIMENTS

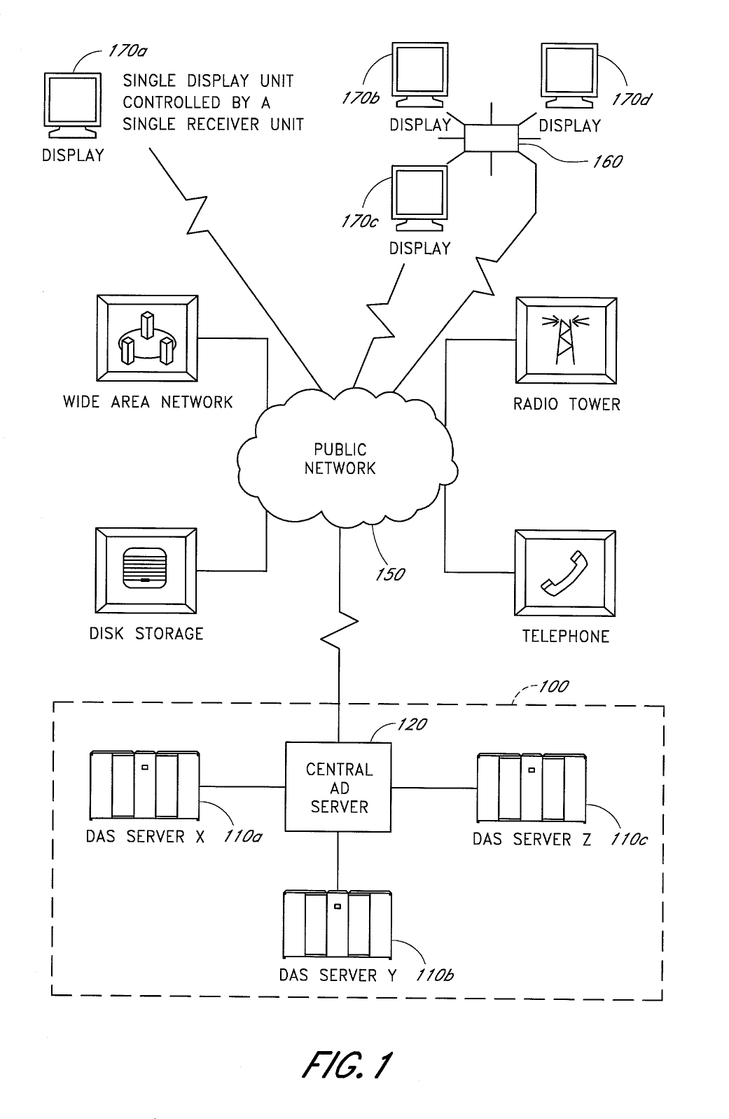

FIG. 1 is a block diagram illustrating one embodiment of an advertising system. Display units 170 are provided at the advertising venues. An advertising venue may be a retail outlet or practically any other area capable of accommodating such display units. For example, display units 170 may be provided along an aisle inside a shopping mall. In one embodiment, the display units are kiosks which provide audio and video advertising to consumers.

In one embodiment, a plurality of display units 170b-d may be connected to a single receiving port unit 160. The port unit 160 may support any number of display units. The use of a port 160 unit may be preferable in, for example, a large store having numerous display units. Also, the port 160 may be useful if a single grocery chain, for example, wishes to link the advertisements in all the stores in its chain.

The display units 170 and the port units 160 are connected to a public network 150. The network may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, an Internet includes network variations such as public internet, a private internet, a secure internet, a private network, a public network, a value-added network, an intranet, and the like. In a preferred embodiment, the public network 150 is the Internet computer network.

The display units 170 and the port units 160 subscribe to an advertising service implemented on an advertising system 100, which may be remotely located from all display units 170, is also connected to the public network 150. The advertising system 100 comprises a central advertising server 120. In one embodiment, the advertising system 100 further comprises a plurality of servers 110a-c connected to the central advertising server 120 via a telecommunications network. In a preferred embodiment, the telecommunications network is an Intranet.

Each server 110, 120 can be a conventional computer system, such as one based on Intel, Sun, IBM or other computer server vendor running server software such as Windows NT or Apache. The link between multiple computer servers is preferably based on the Ethernet standard for providing high throughput communications between each server. The servers 110, 120 may be capable of providing load balancing in providing digital advertising to display units 170.

The servers 110, 120 in the advertising system 100 can store video, text and audio data corresponding to each of a plurality of advertisements. In one embodiment, each advertisement is stored on the servers 110, 120 as a web page. For example, the stored advertisement may contain hypertext markup language (HTML) text and integrated graphic, audio, video or animation data. Portions or all of the advertisement may be stored in a compressed format. For example, the video data may be stored as an MPEG file that is displayed via a Shockwave-compatible plug-in module. Details concerning the Shockwave modules may be found at www.shockwave.com. The advertisement, in the form of a web page, may thus be viewed using a web browser such as Microsoft Internet Explorer or Netscape Navigator.

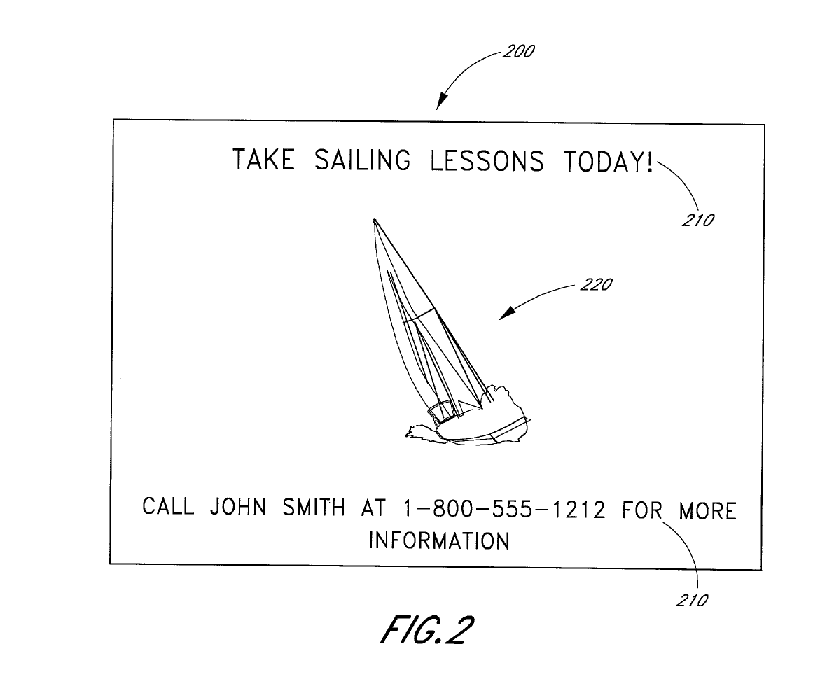

FIG. 2 illustrates one example of an advertisement in the form of a web page. The advertisement 200 comprises text 210 and graphics, video or animation 220. As noted above, the text 210 is in HTML format. The sailboat graphic 220 may be a still graphic, a looped video clip or a looped animation.

Referring again to FIG. 1, the central advertisement server 120 comprises a database (not shown) of client display units 170 and receiving port units 160. Each display unit 170 and port unit 160 is identified in the database by a unique alphanumeric naming code. The naming code may be indicative of such parameters as customer name and location of the display unit or port unit.

The display units 170a-d may be supported by a personal computer running a display software and a content update software. The personal computer is capable of either storing advertisement files or accessing such files from another device, such as a server or a disk storage. Each display unit 170 and/or a corresponding port unit 160 is equipped with a device such as a modem for dial-up or fixed access to the network 150.

In one embodiment, the display units 170a-d are equipped with web-enabled cameras. The cameras may be aimed at the display itself, thus allowing the administrator of the advertisement system to monitor the display. For areas with multiple display units, a single camera may be used to monitor a plurality of display units.

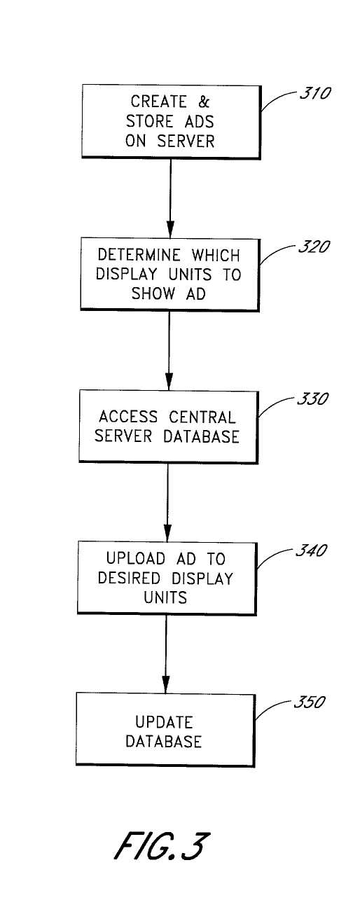

FIG. 3 is a flow chart illustrating the distribution of a new advertisement to the subscribing display units. At state 310, an advertisement is created and stored on one of the servers 110, 120 in the advertisement system 100 illustrated in FIG. 1. The advertisement may be supplied in electronic form to the administrator of the advertisement system 100 by the advertiser. At state 320, the administrator determines which display units are to display the particular advertisement. The display units may be selected to target a particular market, a particular geographic area or a particular demographic, for example. A list of selected display units may be supplied by the advertiser.

At state 330, the advertising system accesses the above-described database to obtain the alphanumeric identification code of each of the selected display units. The database may also include a list of the advertisements currently existing on each display unit. The database may also include a file or an entry indicating the connection through which the advertisement system and the display unit communicate. For example, the connection may be a fixed Internet, dial-up Internet or direct dial-up connection.

At state 340, the advertising system contacts each of the selected display units and uploads the files containing the advertisement. Along with the data files, the advertising system may also upload a display schedule for the advertisement for each unit. For example, the display schedule may indicate the times at which the advertisement is to be displayed or a percentage of the operational time during which the advertisement is to be displayed. Thus, the advertising system's servers can initiate the process of updating the advertisement files on the client display units without receiving a request from the clients first.

The uploading may occur either during a fixed schedule (e.g., once per day) or whenever the advertising administrator initiates an upload process. Each display unit may also initiate an upload if, for example, it had become disconnected from the network. In one embodiment, the uploading is accomplished by transferring the files through a network via the File Transfer Protocol (FTP).

In one embodiment, the uploading process is initiated by the central advertisement server. The central server contacts each display unit to inform that display unit that an update to its files is required. In response, each display unit connects to one of the servers in the advertisement system to obtain the upload. The server to which the display unit connects may be one that has been previously designated to that display unit. This prevents a large number of display units directly contacting the central server at once.

At state 350, the advertising system automatically updates the database to reflect the addition of the advertisement at each of the selected display units. In one embodiment, the database is a set of directories, each directory corresponding to a particular display unit. The database, or directory, may contain an update flag file. The update flag file indicates to the display unit whether or not the advertisement system is requesting to update the advertisement files existing on the display unit.

In another embodiment, the advertisements may be created at the display units themselves. Thus, the merchant at each display unit, for example, may add his own advertisements to those uploaded by the central advertisement server.

Once the advertisement has been uploaded to the individual display units, it may be modified by simply modifying the appropriate file. In one embodiment, the advertiser can remotely modify the advertisement by connecting to the display unit via a network such as the Internet. Updating of a display unit may be performed through a Content Wizard. The Content Wizard is a Windows-based application which allows a user to select and sequence display files into the display sequence for the selected unit. Upon selection and sequencing of the content for a display unit, the updated material may be submitted to the display unit.

The display units execute a display engine to display the advertisements. The advertisements may comprise multimedia files of varying types. In one embodiment, the advertisements may be stored in Synchronized Multimedia Integration Language (SMIL) files.

Since the necessary advertisement files and the required software exist on each display unit, the display units are capable of autonomous operation. Thus, even if the display unit is not always connected to the advertisement system, its browser will continue to display all of the advertisements that have been uploaded to it by the servers.

Each display unit is capable of displaying broadcast-quality, World Wide Web-quality, or still slide advertisements. The size of the display unit may be varied as appropriate for the venue.

Thus, the invention provides tremendous advantages in speed and flexibility. For example, if a new advertiser wishes to have their ads placed within a series of supermarkets, only one advertising page is created and stored on the server. As soon as the advertising page is stored, it can be transmitted to each of the designated supermarkets for display. As can be imagined, the system includes software for determining which display will show a particular advertisement. For example, if one of the advertisements relates to a special on Safeway frozen food, that advertisement is only shown on display units within Safeway stores.

Another advantage of the invention is the ability to show advertisements on a predetermined schedule in order to comply with particular contracts. Thus, one chain of supermarkets may agree to allow the display units on their premises with the promise that their own ads would run 50% of the time. The system would simply determine the ad cycle for each individual supermarket display and then time the advertisements so that 50% of the ads were from the supermarket.

Each advertisement preferably only runs for a few seconds. Of course, advertisers that wanted their ad to stay resident on the display screen for longer periods of time would pay a greater amount of money. As noted above, most advertisements would be a compilation of text and a short video with sound. This would allow each advertiser the ability to present a short message to the public. The short message would then be repeated throughout the day on the video screen.

Because each advertisement is preferably stored locally on the display units, each display unit can be programmed to display varying patterns of ads. The supermarket display units can advertise for services and products from its local area, along with its own supermarket ads. On the other hand, a hardware store may display ads from its own store, along with service and products appropriate for hardware store customers.

The combination of servers, with appropriate redundancy, ensure that the display units in the field operate with the highest possible reliability. The combination of servers is designed in such a way as to ensure that appropriate load-balancing occurs. This becomes a greater issue for the system as broadcast-quality video streams become the norm, rather than the exception.

The system is constructed to ensure that the display units are updated in a timely manner, depending on the type of the update and the venue of the display unit. For example, to update a full motion video into a running display unit within a high-traffic merchant would not be appropriate and, therefore, would occur during off hours only. As a second example, a small real estate advertisement that reflects a change in a home price or a just-sold condition may be updated at once by the delivery system.

The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A system for providing advertising, comprising:
a server computer configured to store advertising data;
one or more display computers, said display computers having a software module configured to display advertisements corresponding to said advertising data; and
a communication module located in said server computer, said communication module being configured to update said advertising data at said display computers, wherein said server computer is configured to initiate updating of said advertising data at said display computers.

2. The system for providing advertising according to claim 1, wherein said advertising data includes audio data.

3. The system for providing advertising according to claim 1, wherein said advertising data includes graphic data.

4. The system for providing advertising according to claim 1, wherein said advertising data includes video data.

5. The system for providing advertising according to claim 1, wherein said advertising data includes text data.

6. The system for providing advertising according to claim 1, wherein said communication module is configured to transmit data over a network.

7. The system for providing advertising according to claim 6, wherein said network is the Internet.

8. The system for providing advertising according to claim 1, wherein said communication module is configured to transmit data via a File Transfer Protocol (FTP) connection.

9. A method for distributing advertising data, comprising:
storing advertising data on a server computer;
transmitting said advertising data to one or more display computers; and
displaying said transmitted advertising data on said display computers.

10. The method for distributing advertising data according to claim 9, wherein said transmitting includes accessing a database to determine to which of a plurality of display computers to transmit said advertising data.

11. The system for providing advertising according to claim 10, wherein said transmitting includes updating said database to indicate said transmission.

12. A system for providing advertising, comprising:
a server computer configured to store advertising data;
a communication module located in said server computer, said communication module being configured to transmit said advertising data to one or more display computers; and
a software module residing on said display computers, said software module being configured to display said transmitted advertising data.
